(19) United States
(12) Patent Application Publication
(10) Pub. No.: US 2006/0203256 A1
(43) Pub. Date: Sep. 14, 2006

(54) Setting management apparatus, setting management method and setting management program

(75) Inventor: Takahiro Hagiwara, Chiba-shi (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/076,379

(22) Filed: Mar. 10, 2005

(51) Int. Cl. G06F 3/12; G06K 15/00

(52) U.S. Cl. 358/1.1; 358/1.13; 358/1.16

(57) ABSTRACT

A setting management apparatus, a setting management method and a setting management computer program allow the user to enjoy a high degree of freedom in terms of setting a printing environment and improve convenience on the part of the user for the printing process. A setting management apparatus for managing setting information relating to image forming processes for forming images on respective sheets comprises a setting information acquiring section 101a for acquiring the setting information defined corresponding to jobs of the image forming processes and a setting executing section 104 for sequentially executing the image forming processes of a plurality of jobs at predetermined respective timings according to the setting information acquired by the setting information acquiring section 101a for the plurality of jobs in response to the acquisition of the setting information for the plurality of jobs.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosure as it appears in the Patent and Trademark Office patent files or records, but otherwise reserves all copyright and trade dress rights whatsoever.

### RELATED APPLICATION INFORMATION

This patent is related to, which is incorporated herein by reference.

### BACKGROUND OF THE INVENTION

1. Field of the Invention

The present invention relates to a setting management apparatus, a setting management method and a setting management program.

2. Description of the Related Art

Printing processing techniques for realizing a printing quality or a printing time wanted by a user by setting a printing environment for “giving priority to the printing speed” or “giving priority to the image quality” in an image forming apparatus are known. Such techniques involve changing the printing resolution and/or the color conversion process.

However, with any of the known techniques, the user generally has to select either “giving priority to the printing speed” or “giving priority to the image quality” or select “giving priority to the printing speed”, “giving priority to the image quality” or “standard” at most. Therefore, the known techniques do not give a high degree of freedom to the user in terms of setting a printing environment. In other words, it may not possible for the user to set a desired printing environment.

With any of the above described known techniques, if the user wants to print a number of copies of different types including, for example, three color copies for important clients and twenty black and white copies for the other, he or she may has to print three color copies first and subsequently change the setting for printing so as to print twenty black and white copies. Such an operation of changing the setting for printing may be a burden on the part of the user.

In view of the above identified problem, it is therefore an object of the present invention to provide a setting management apparatus, a setting management method and a setting management computer program that allow the user to enjoy a high degree of freedom in terms of setting a printing environment and improve convenience on the part of the user for the printing process

### DESCRIPTION OF THE DRAWINGS

FIG. 1 is a schematic functional block diagram of an image processing apparatus comprising an embodiment of setting management apparatus according to the invention.

FIG. 2 is an illustration of a displayed image for a printing environment setting operation (driver image) of the display section 3.

FIG. 3 is a flow chart of the operation of the sliding bar 301a interlocked with the contents of the items of the setting list 301b.

FIG. 4 is a detailed illustration of the rule of correspondence that is used for the purpose of the present invention.

FIG. 5 is a schematic illustration of computations for speed and quality that are used for the purpose of the present invention.

FIG. 6 is another schematic illustration of computations for speed and quality that are used for the purpose of the present invention.

FIG. 7 is a flow chart illustrating a method for determining the slide bar position when the setting is changed.

FIG. 8 is a flow chart illustrating a method for determining the contents of the related items from the slide bar position.

FIG. 9 is another flow chart illustrating the method of FIG. 8 for determining the contents of the related items from the slide bar position.

FIG. 10 is a flow chart illustrating the flow of the overall process of the operation of the sliding bar 301a interlocked with the contents of the items of the setting list 301b.

FIG. 11 is a schematic illustration of a printing process using a combination of an S/W process and an H/W process.

FIG. 12 is a schematic illustration of another printing process using a combination of an S/W process and an H/W process.

FIG. 13 is a schematic illustration of still another printing process using a combination of an S/W process and an H/W process.

FIG. 14 is a flow chart of the image forming process of image processing apparatus M on a sheet.

FIG. 15 is a flow chart of an operation of collectively carrying out a plurality of printing jobs.

FIG. 16 is a schematic illustration of a displayed image for an operation of collectively carrying out a plurality of printing jobs.

FIG. 17 is a schematic illustration of another displayed image for an operation of collectively carrying out a plurality of printing jobs.

FIG. 18 is a schematic illustration of still another displayed image for an operation of collectively carrying out a plurality of printing jobs.

FIG. 19 is a flow chart of an overall operation of collectively carrying out a plurality of printing jobs.

### DETAILED DESCRIPTION OF THE INVENTION

An embodiment of the present invention will be described below with reference to the accompanying drawings.

Throughout this description, the embodiments and examples shown should be considered as exemplars, rather than limitations on the apparatus and methods of the present invention.

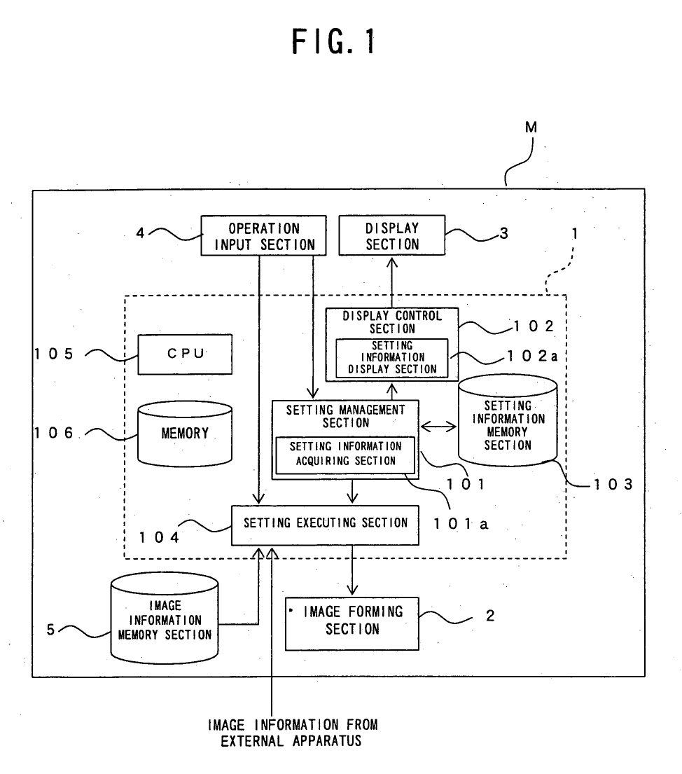

FIG. 1 is a schematic functional block diagram of an image processing apparatus comprising an embodiment of setting management apparatus according to the invention.

The image processing apparatus M of FIG. 1 comprises an embodiment of setting management apparatus 1 according to the invention, an image forming section 2, a display section 3, an operation input section 4 and an image information memory section 5.

The setting management apparatus 1 of this embodiment takes a role of managing the setting information relating to an image forming process that is conducted on a sheet and comprises a setting management section 101, a display control section 102, a setting information memory section 103, a setting executing section 104, a CPU 105 and a memory 106.

The setting information memory section 103 takes a role of storing the setting information that is defined corresponding to the job of an image forming process and a rule correspondence, which will be described in greater detail hereinafter, and is typically formed by using an HDD. The expression of setting information as used herein refers to priority setting information that indicates the priority that is given either to the image quality or the time required for an image forming process and parameter setting information on the parameters that influence the image quality and the processing time. Such setting information is defined according to the user operation input received at the operation input section 4.

When either the priority setting information or the parameter setting information of the information stored in the setting information memory section 103 is modified, the setting management section 101 takes a role of modifying the parameter setting information or the priority setting information, whichever appropriate. The setting management section 101 includes a setting information acquiring section 110a for acquiring the setting information that is defined corresponding to the job of an image forming process. While the setting management section 101 includes the setting information acquiring section 111a in this embodiment, the present invention is by no means limited thereto and the setting management section 101 and the setting information acquiring section 110a may be provided as separate functional units for the purpose of the present invention.

The display control section 102 takes a role of causing the display section 3 to display the setting information that is defined corresponding to the job of an image forming process as acquired by the setting information acquiring section 110a. The display control section 102 includes a setting information display section 102a for causing the display section 3 to display the priority setting information and the parameter setting information acquired by the setting information acquiring section 110a. While the display control section 102 includes the setting information display section 102a in this embodiment, the display control section 102 and the setting information display section 102a may be provided as separate functional units for the purpose of the present invention.

The setting executing section 104 takes a role of causing the image forming section 2 to sequentially execute the image forming process according to the pieces of setting information for a plurality of jobs at predetermined timings when the setting information acquiring section 111a acquires setting information for the plurality of jobs.

The CPU 105 takes a role of conducting various processes in the image processing apparatus M by executing the programs stored in the memory 106. The memory 106 is typically formed by using a ROM and/or a RAM and takes a role of storing the programs to be executed by the CPU 105 and various pieces of information to be used in the image processing apparatus M.

The image forming section 2 takes a role of forming an image on a sheet. The display section 3 takes a role of displaying an image according to the instruction from the display control section 102 or the setting information display section 102a. It is typically formed by using a CRT display or a liquid crystal display. The operation input section 4 takes a role of receiving the operation input of the user. It is formed by using a keyboard, a mouse and the like. However, it will be appreciated that it is not necessary to provide the display section 3 and the operation input section 4 as separate functional units and they may alternatively be formed by means of a touch panel display or the like. The image forming section 2 conducts an image forming process according to the data on an image stored in the image information memory section 5. However, it will be appreciated that the image forming section 2 may be adapted to conduct an image forming process according to the image information transmitted from an external information source communicably connected to the image processing apparatus M.

The image information memory section 5 takes a role of storing data relating to the image to be formed on a sheet by the image forming section 2 and is typically formed by using an HDD.

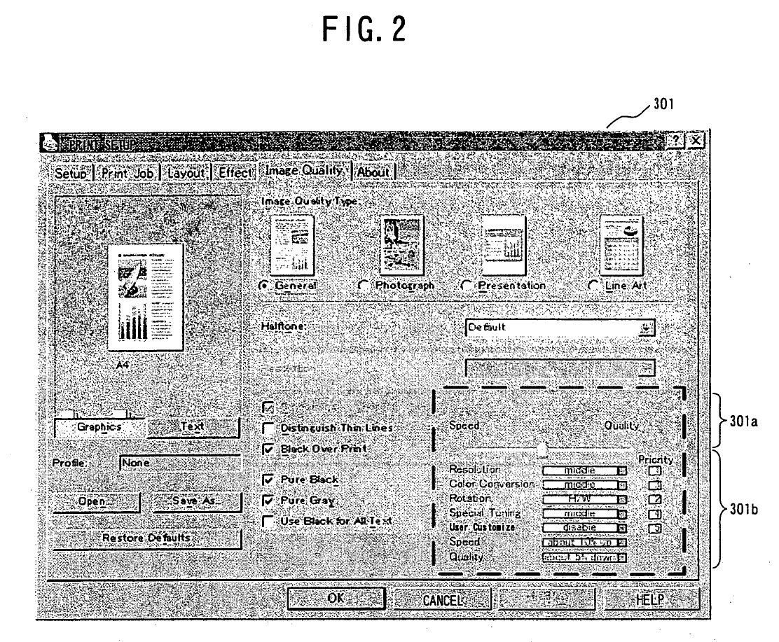

FIG. 2 is an illustration of a displayed image for a printing environment setting operation (driver image) of the display section 3. As shown in FIG. 2, this embodiment is so adapted that the specification given for the coming printing session such as “giving priority to the printing speed” or “giving priority to the image quality” is displayed as a continuously changeable value by a sliding bar 301a in a window 301 (setting information display step).

The sliding bar 301a takes a role of operating as interface for setting a printing environment by an analog (continuously changeable) value that can take an intermediate value between “Speed (giving priority to printing speed)” and “Quality (giving priority to image quality)” as it is made to slide horizontally according to the operation input from the operation input section 4. With this arrangement, the user can select an intermediate value he or she wants for the coming printing session.

The setting list 301b in FIG. 2 takes a role of operating as interface for displaying the setting for the coming printing session typically including items (parameter setting information) such as “Resolution”, “Color Conversion”, “Rotation”, “Special”, “User Customize”, “Speed” and “Quality”. A choice is given to the user for each item in the form of a pull down menu that appears according to the operation input at the operation input section 4. For example, a choice of “high”, “middle” and “low” is provided for “Color Conversion”.

In this embodiment, the setting management section 101, when either the setting (the position of the sliding bar) (the priority setting information) as determined by means of the sliding bar 301a or the setting (of the items) (the parameter setting information) as defined in the setting list 301b is modified, the setting management section 101 modifies the parameter setting information or the priority setting information, whichever appropriate, according to a rule of correspondence defining the corresponding relationship of the priority setting information and the parameter setting information.

As described above, the contents of the setting list are modified according to the position of the sliding bar or the position of the sliding bar is shifted according to the contents of the setting list so that the user can visually grasp the current setting and the effects of the setting.

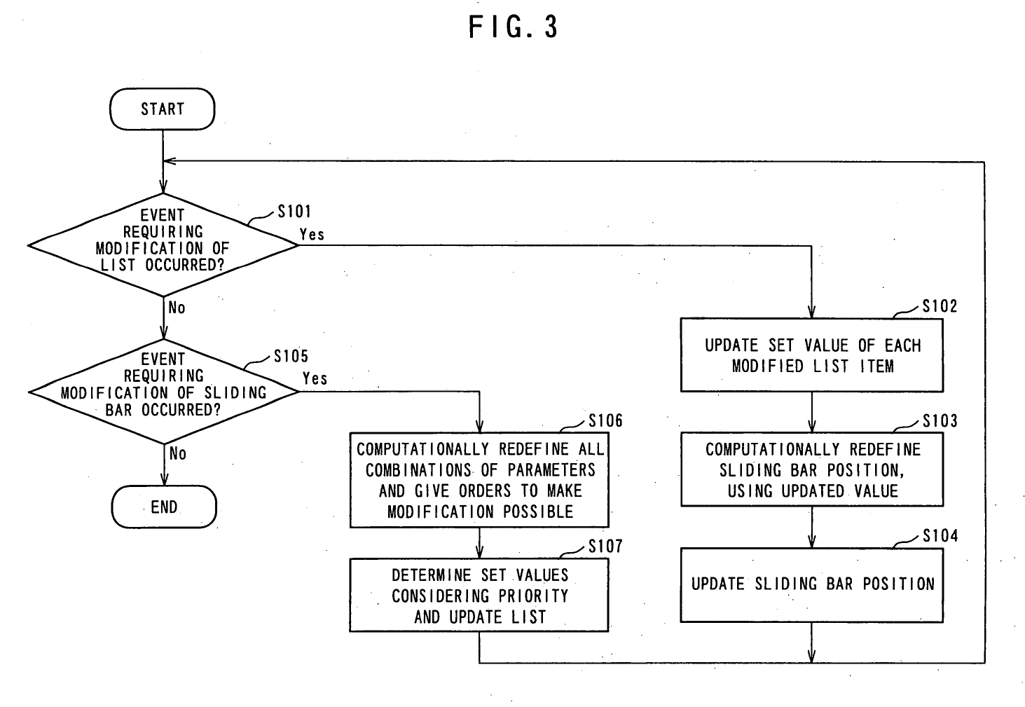

FIG. 3 is a flow chart of the operation of the sliding bar 301a interlocked with the contents of the items of the setting list 301b.

When an event that the contents of the setting list 301b are modified takes place (S101, Yes), the setting management section 101 updates the information of the item whose contents are modified (S102).

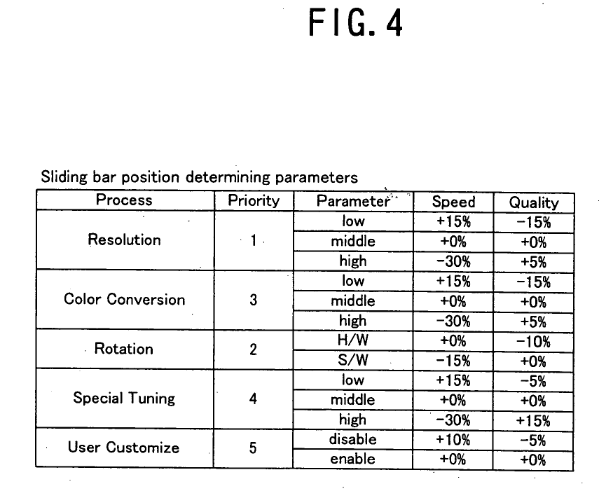

Then, the setting management section 101 computes the position of the sliding bar 301a that corresponds to the updated information (on the modified contents) of the item according to the rule of correspondence defining the corresponding relationship of the priority setting information and the parameter setting information (see FIG. 4) (S103) and causes the display section 3 to update the image of the sliding bar 301a (S104).

When, on the other hand, there is no event that the contents of the setting list 301b are modified (S101, No) but an event that the setting defined by the sliding bar 301a is modified takes place (S105, Yes), the setting management section 101 computationally determines various combinations of the contents of the items that may match the modified setting as defined by the sliding bar 301a according to the rule of correspondence and gives respective orders of priority to the combinations (S106).

Then, the setting management section 101 updates the contents of the setting list 301b of the display section 3, considering the orders of priority of the combinations of the contents of the items of the setting list as computationally determined in a manner as described above (S107).

Now, the operation of the sliding bar 301a interlocked with the contents of the items of the setting list 301b will be described in detail below.

The influence of the contents of each of the items of the setting list 301b on “Speed” and “Quality” are defined in advance as shown in FIG. 4. The definitions vary from each type of image processing apparatus to another because H/W and SIW vary from each type of image processing apparatus to another.

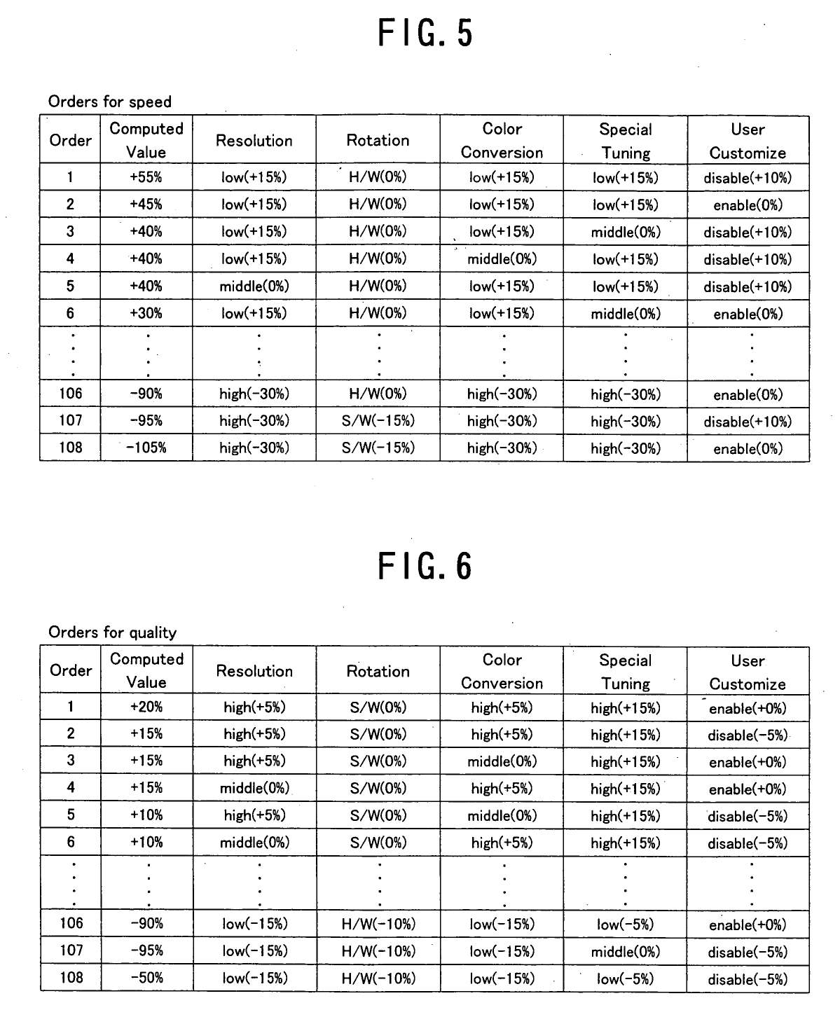

Firstly, FIGS. 5 and 6 are prepared by computing the values of Speed and Quality for all the combinations of Processes and Parameters. The values listed in FIGS. 5 and 6 are obtained by simply adding the values expressed in percent for Resolution, Rotation, Color Conversion, Rotation, Special Tuning and User Customize. They are arranged in the descending order of values and, if there are same values, the value having a higher priority is listed above relative to the other same value.

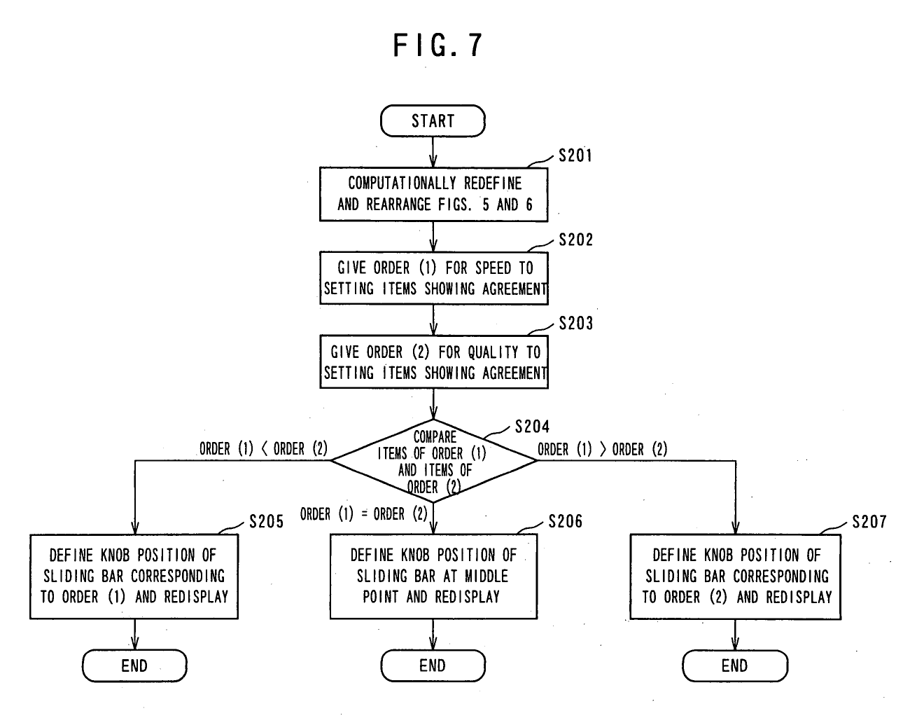

The position of the sliding bar is determined in a manner as described below by referring to the flow chart of FIG. 7 when the contents of the items (Resolution/Rotation/Color Conversion/Special Tuning/User Customize) of the setting list are modified. When the contents of the items of the setting list are modified, the values of FIGS. 5 and 6 are updated by computations and rearranged (S201). Subsequently, the orders (1) for “giving priority to the printing speed” (S202) and the orders (2) for “giving priority to the printing quality” (S203) are determined. Then, the orders (1) and the orders (2) are compared (S204). If the order (1) of an item is higher than the order (2) of the item, the position of the sliding bar is redefined so as to be located at the point corresponding to the order (1) for that item and redisplayed (S205). If, to the contrary, the order (2) of the item is higher than the order (1) of that item, the position of the sliding bar is redefined so as to be located at the point corresponding to the order (2) for the item and redisplayed (S207). Finally, if the order (1) of the item and the order (2) of that item are equal to each other, the position of the sliding bar is redefined so as to be located at the middle point (S206).

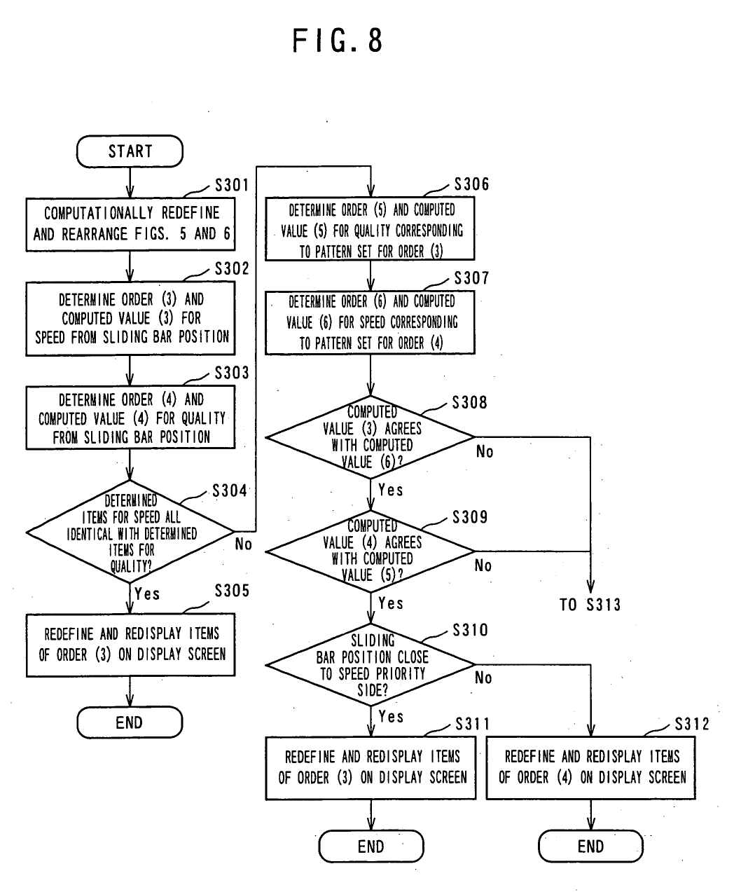

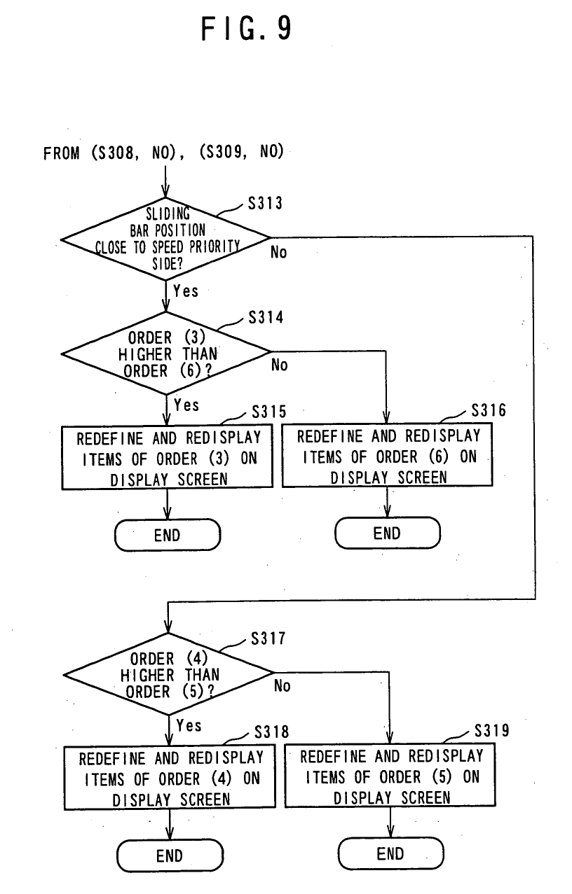

Now, how the contents of each of the items of the setting list are determined on the basis of the position of the sliding bar will be described by referring to the flow charts of FIGS. 8 and 9. When the position of the knob of the sliding bar is shifted, the values of FIGS. 5 and 6 are recomputed and rearranged (S301). Subsequently, the order (3) and the computed value (3) of “giving priority to the printing speed” that correspond to the position of the knob of the sliding bar (S302) and also the order (4) and the computed value (4) (S303) are determined for each of the items. Then, if the order (3) for “giving priority to the printing speed” and the order (4) for “giving priority to the printing quality” agree with each other (S304, Yes), the contents of the items with the order (3) are redefined and redisplayed (S305). If, on the other hand, they don't agree with each other (S304, No), the order (5) and the computed value (5) of “giving priority to the printing quality” same as those of the item or items defined with the order (3) of “giving priority to the printing speed” are determined (S306). Similarly, the order (6) and the computed value (6) of “giving priority to the printing speed” same as those of the item or items with the order (4) of “giving priority to the printing quality” are determined (S307). Then, if the computed value (3)=the computed value (6) (S308, Yes) and the computed value (4)=the computed value (5) (S309, Yes), the contents of the item or items with the order (3) are redefined and redisplayed (S311) provided that the position of the knob of the sliding bar is located closer to the side of “giving priority to the printing speed” (S310, Yes), whereas the contents of the item or items with the order (4) are redefined and redisplayed (S312) provided that the position of the knob of the sliding bar is located closer to the side of “giving priority to the printing quality” (S310, No). The middle position of the sliding bar is regarded as it is located close to the side of “giving priority to the printing speed”. Otherwise, the contents of the item or items with the order (3) or the order (6), whichever higher, are redefined and redisplayed (S315, S316) provided that the position of the sliding bar is located closer to the side of “giving priority to the printing speed” (S313, Yes), whereas the contents of the item or items with the order (4) or the order (5), whichever higher, are redefined and redisplayed (S318, S319) provided that the position of the sliding bar is located closer to the side of “giving priority to the printing quality” (S313, No).

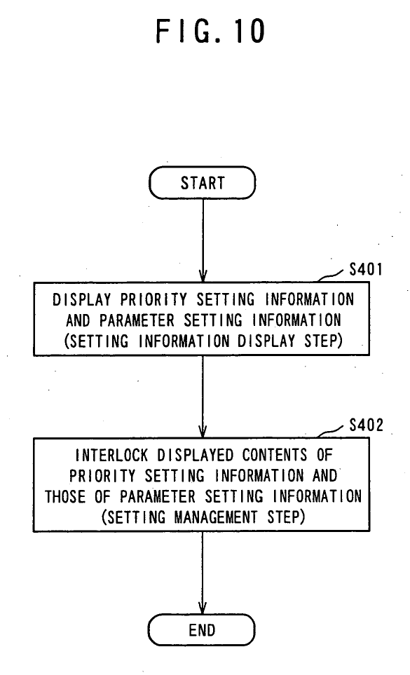

FIG. 10 is a flow chart illustrating the flow of the overall process of the operation of the sliding bar 301a interlocked with the contents of the items of the setting list 301b.

Firstly, the setting information display section 102a displays priority setting information showing if priority is given to the image quality of the image forming process or to the time required for the image forming process and parameter setting information showing the parameters that affect the image quality and the time (setting information display step) (S401). At this time, the setting information display section 102a displays the setting of the priority setting information as a continuously changeable value by means of a sliding bar.

When either the priority setting information or the parameter setting information of the information is modified, the setting management section 101 modifies the parameter setting information or the priority setting information, whichever appropriate (setting management step) (S402). More specifically, when either the priority setting information or the parameter setting information of the information is modified, the setting management section 101 modifies the parameter setting information or the priority setting information, whichever appropriate, according to the rule of correspondence defining the corresponding relationship of the priority setting information and the parameter setting information.

With the above-described arrangement, it is easy for the user by using the sliding bar 301a to grasp the influence of each of various image processes (various settings for printing) on the desired printing quality and hence how the printing environment needs to set to realize the desired printing quality (image quality and the printing speed). Additionally, since the contents of the items of the setting list can be modified to satisfy the user, it is possible for the user to make various adjustments in order to obtain an optimal printing speed and an optimal image quality.

Additionally, the user can give priority either to “the printing speed” or to “the printing quality” in an analog manner by adjusting the position of the sliding bar 301a. In other words, the user can set the printing environment by selecting a desired printing speed and a desired image quality in a well-balanced manner.

Now, an example of image forming process and parameter settings will be described for a case where “giving priority to the image quality” is selected and a case where “giving priority to the printing speed” is selected by means the sliding bar 301a.

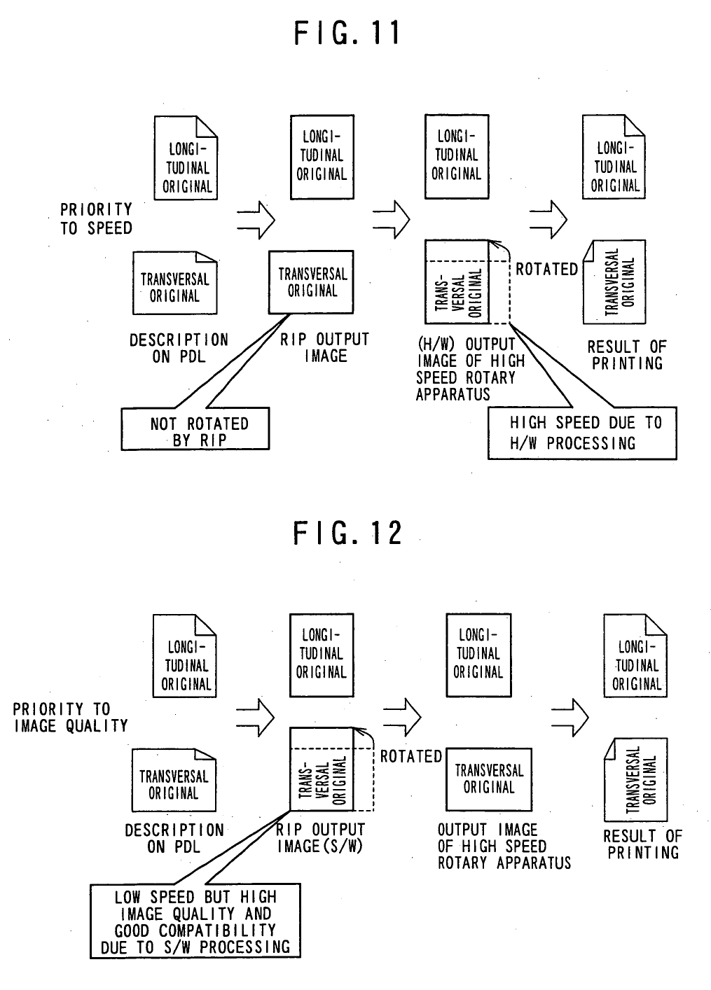

Firstly, a rotary process will be described. When an image is formed according to the image information on a longitudinally directed original or a transversally directed original by PDL received from an external information source such as a PC (personal computer), the bit map image or the like arranged in the original needs to be rotated depending on the lying direction of the sheet on which the image is to be formed. A RIP (raster image processing) operation is conducted by using a memory having a relatively small memory capacity in ordinary image forming apparatus. Therefore, while the load of the processing operation is small when an image of a longitudinally directed original is printed on a longitudinally directed sheet because it does not involve any bit map rotation process, the load of the processing operation will be heavy when an image of a transversally directed original is printed on a longitudinally directed sheet when an image of a longitudinally directed original is printed on a transversally directed sheet because it involves a bit map rotation process. Such a heavy load can be an obstacle for raising the speed of the image forming process. In view of the above identified circumstances, as shown in FIG. 11 the setting management section 101 selects parameters from the setting list 301b that can realize a high speed rotation process by optimally combining a RIP process, which is a S/W (software) process, and a rotary device, which operates for a H/W (hardware) process.

When a process as illustrated in FIG. 11 is conducted, an unexpected outcome of the printing operation can arise because of the compatibility of the involved application programs and/or the screen may not be optimal and adversely affected by the jitter of the printing engine depending on the sense of rotation. The net result will be a printed image of a poor image quality. If such a problem arises, it is possible to select parameters from the setting list 301b according to the rule of correspondence so as to give priority not to “the printing speed” but to “the image quality” (see FIG. 12).

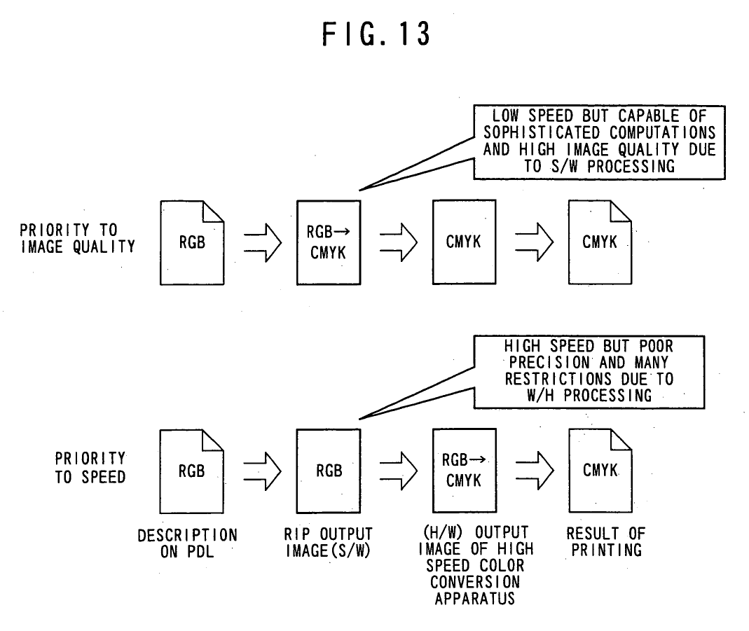

The above description also applies to a color conversion process. When an image is expressed by means of an RGB color space, it is sometimes necessary to conduct a color conversion process to a CMYK color space for forming an image. If a delicate vicissitude of colors has to be reproduced, it is necessary to carry out highly sophisticated computational operations and use a large size LUT (look-up table). Then, the memory access time increases because the access effort can go astray from the cache memory as shown in FIG. 13. The net result will be a printed image of a poor image quality. If, on the other hand, delicate differences of colors between the original and the image formed on a sheet are negligible to a certain extent, it is possible to raise the printing speed.

Now, the resolution will be discussed. Generally, small characters and graphics are reproduced with a high degree of fidelity and the gradations are smooth to improve the image quality but the printing speed is low when the resolution of the image formed on a sheet is high. Conversely, the printing speed is high but the image quality is poor when the resolution of the image formed on a sheet is low.

Additionally, a specific setting made by the user can also affect the image quality and the printing speed. For example, a setting other than the default selected for the purpose of satisfying the user's taste such as corrected lightness and/or corrected contrast can raise the load of the image forming process and lower the printing speed. Furthermore, the image quality improving process that is provided for improving the quality of the image being formed generally reduces the printing speed. In other words, the printing speed can be raised when the process is omitted because the image quality does no give rise to any particular problem if the process is omitted. As pointed out above, there are a number of processes and parameters that affect the image quality and the printing speed so that the user can select a desired printing speed and a desired image quality in a well-balanced manner when he or she really understand some of the processes and the parameters.

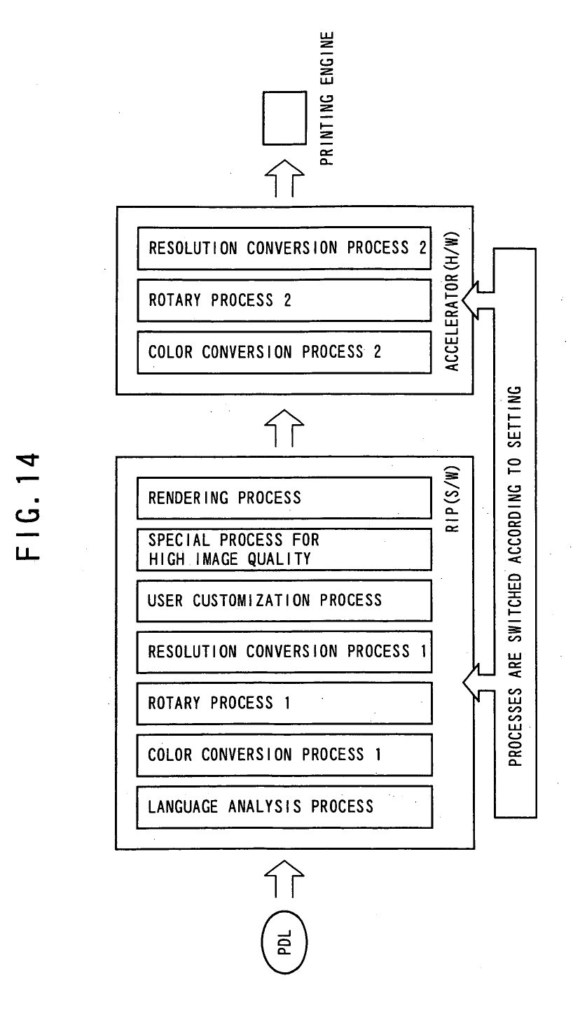

FIG. 14 is a flow chart of the image forming process of image processing apparatus M on a sheet. An S/W process is conducted in the RIP in the former half of the image forming process and an H/W process is conducted by means of an accelerator in the latter half of the image forming process. The S/W process is switched to the H/W process according to the setting information and the image forming process proceeds also according to the setting information.

Next, handling of a job of the image forming process in the setting management apparatus 1 of this embodiment will be described.

Normally, there are a number of setting items provided for the printer driver (including priority setting information and parameter setting information). Such setting items typically include selection of color printing or black and white printing, selection of the number of copies, definition of the image quality, selection of two side printing or one side printing and selection of Nin1 for printing a plurality of pages of the original on a single page.

Generally, the ongoing application program is confined when a job is being executed for a printing process and the next job is not executed for the printing process until the application program is freed. Therefore, if the user wants to print three color copies and twenty black and white copies of an original, he or she has to print either color copies or black and white copies with a right setting first and then change the setting in order to print black and white copies or color copies, whichever appropriate. Additionally, when printing a large number of copies, a long time has to be spent before the application program is freed so that the user is bound to the printing operation for such a long time.

In the setting management apparatus 1 of this embodiment, the setting information defined according to the operation input of the user that is received by way of the operation input section 4 is stored in the setting information memory section 103 for each job and the setting information acquiring section 111a acquires the setting information selected corresponding to the job for the image forming process (setting information acquiring step).

When setting information of a plurality of jobs is acquired in the setting information acquiring step, the setting executing section 104 of the setting management apparatus 1 can sequentially execute the jobs of the image forming process according to the respective pieces of setting information and also according to the respective commands (at the respective predetermined timings) for staring the jobs of the image forming process input by the user by way of the operation input section 4 (setting-conforming execution step). Therefore, the user can cause the image forming section 2 to output (print) with a plurality of different settings that are selected by a single operation for the purpose of copying the same original is copied with different settings. With this arrangement, it is possible to define all the different settings in advance before executing the printing process to a great advantage of the user in terms of reducing the time during which the user is bound to the printing operation. The binding time will be further reduced and the efficiency of the printing operation will be improved significantly if the user stores the plurality of settings and reuse them.

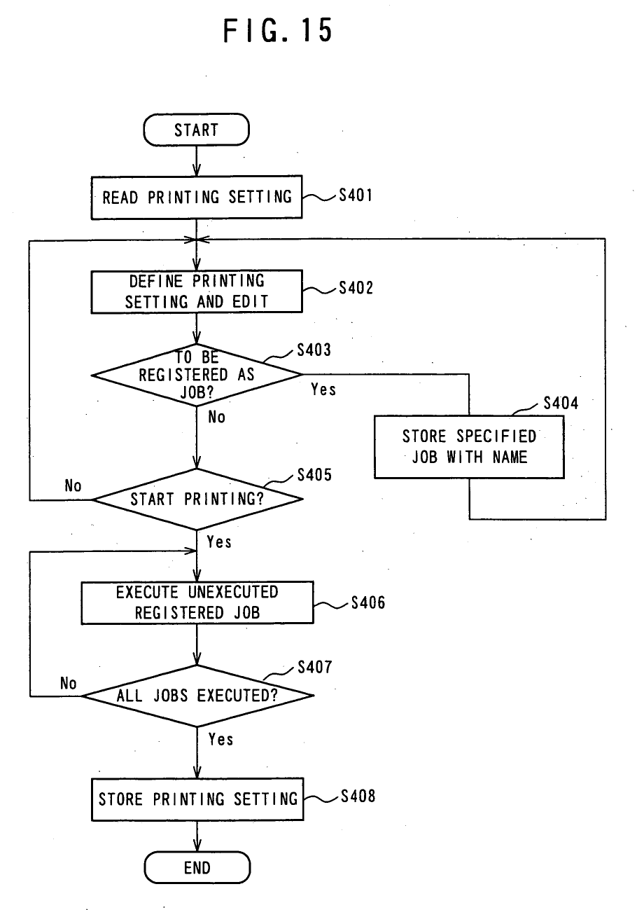

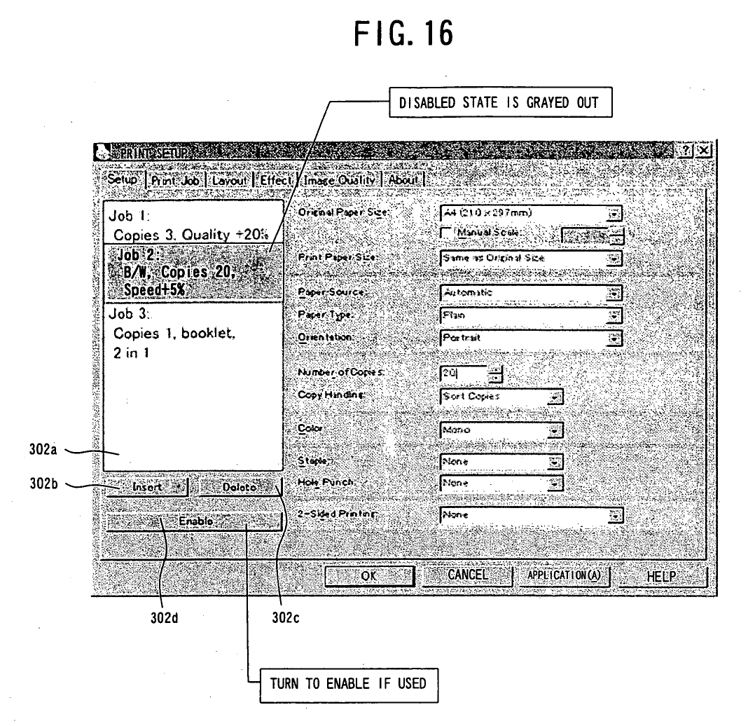

FIG. 15 is a flow chart of an operation of collectively carrying out a plurality of printing jobs. In this embodiment, the setting information defined according to the operation input of the user that is received by way of the operation input section 4 is stored in the setting information memory section 103 for each job and the setting information acquiring section 111a acquires the stored setting information (S401). The display control section 102 causes the display section 3 to display the acquired setting information that is sorted for each job in the job display region 302a (display control step) (see FIG. 16) so that the user can edit the setting information by way of the operation input section 4 (S402).

For editing the contents of each item of the setting list, a job can be added to the job display region 302a by means of the “Insert” button 302b (S403, Yes) or deleted from the jog display region 302a by means of the “Delete” button 302c. The setting information of the registered job is stored in the setting information memory section 103 (S404).

Each of the jobs displayed in the job display region 302a may be made effective by means of the “Enable” button 302d and included in the printing jobs to be executed or ineffective by means of the “Disable” button 302d′ and excluded from the printing jobs to be executed.

When completed the editing operation, the user operates either the “Application” button or the “OK” button for execution of the image forming process (S405), the setting executing section 104 executes sequentially and continuously the printing processes of all the jobs from the highest order job (Job1) to the lowest order job (Job3) that are made “effective” by the “Enable” button 302d (S406, S407). Then, it stores the contents of the printing settings used for the printing processes in the setting information memory section 103 so as to make them available for the next printing operation (S408).

With the above described arrangement, when the user wants to print the same document in a plurality of different settings, it is possible for the user to define the plurality of different settings in advance and issue a command for execution of the printing processes only once to minimize the time during which the user is bound to the printing processes.

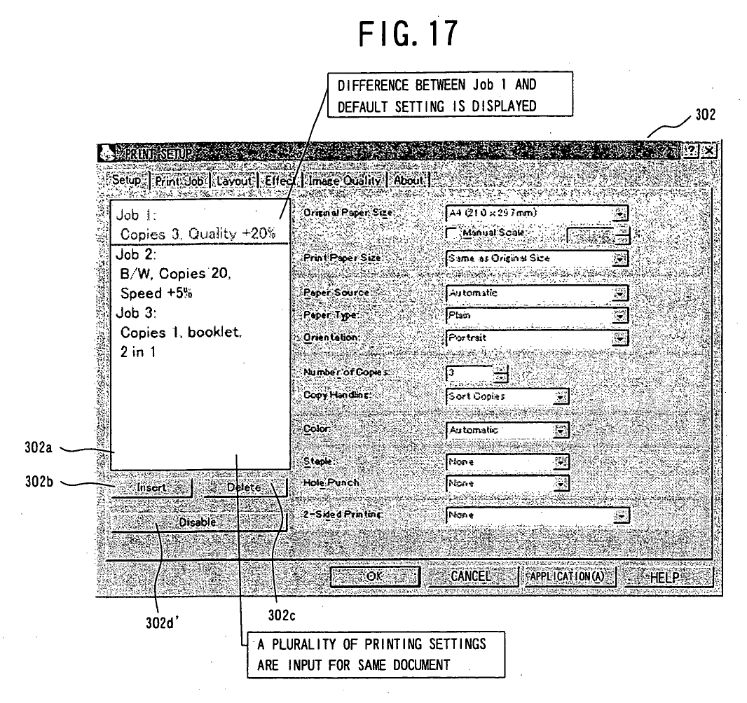

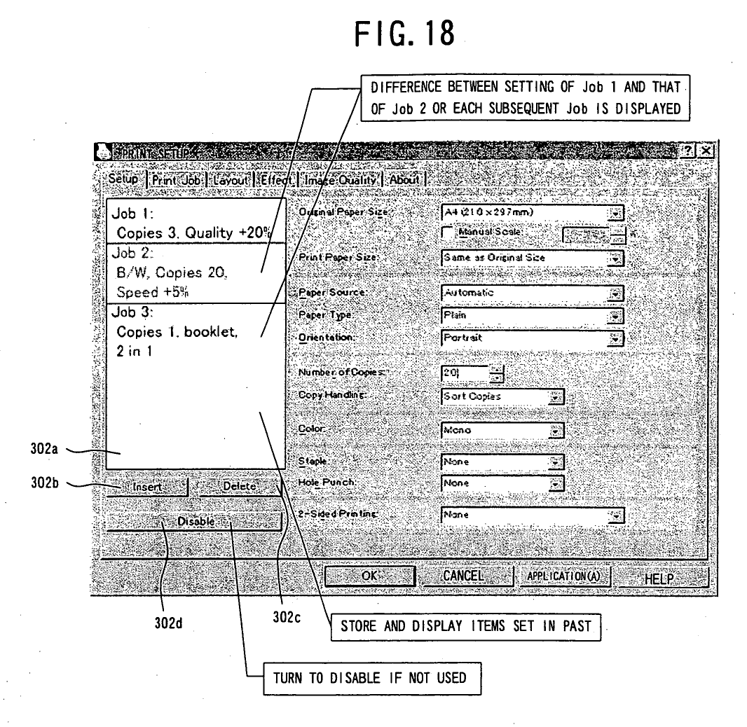

If setting information is acquired for a plurality of jobs, the display control section 102 causes the display section 3 to display the acquired setting information in terms of the difference between the acquired setting information and predetermined standard setting information (default) as shown in FIG. 17 (display control step). Alternatively, the display control section 102 can cause the display section 3 to display the setting information other than the specific setting information (e.g., the setting information for Job1 that is listed as the highest order job) in the acquired plurality of pieces of setting information in terms of the difference between it and the specific setting information (Job1) as shown in FIG. 18.

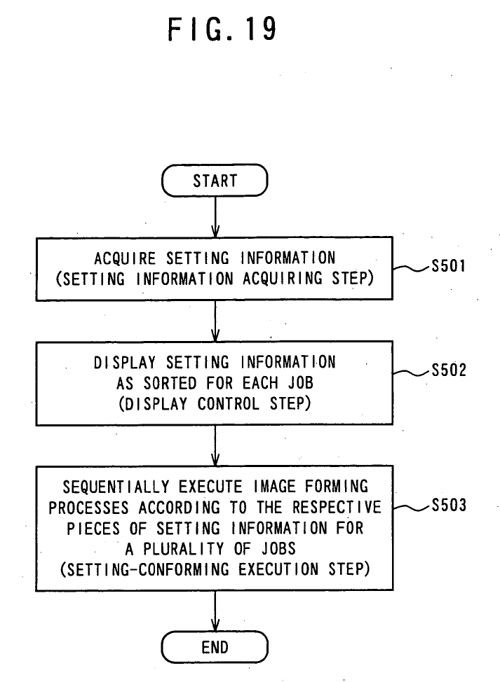

FIG. 19 is a flow chart of an overall operation of collectively carrying out a plurality of printing jobs.

The setting information acquiring section 101a acquires the setting information defined corresponding to the jobs of the image forming processes (setting information acquiring step) (S501).

The display control section 102 sorts the setting information acquired in the setting information acquiring step for the jobs and causes the display section 3 to display the acquired setting information in terms of the difference between the acquired setting information and the predetermined standard setting information (display control step) (S502). Alternatively, the display control section 102 can cause the display section 3 to display the setting information other than the specific setting information in the acquired plurality of pieces of setting information in terms of the difference between it and the specific setting information.

When setting information is acquired for a plurality of jobs in the setting information acquiring step, the setting executing section 104 executes sequentially and continuously the image forming processes of all the jobs according to the setting information for the plurality of jobs in response to a command for starting the image forming processes (setting executing step) (S503).

The processing operations of each step of the illustrated flow charts of this embodiment are realized as the CPU 105 executes the setting management program (setting management method) stored in the memory 106.

While the setting management apparatus 1 of this embodiment is arranged in the image processing apparatus M in the above description, the present invention is by no means limited thereto and a setting management apparatus 1 according to the invention may be arranged in an external apparatus such as a PC that is communicably connected to the image processing apparatus M.

Although shown implemented in a personal computer, the invention may be implemented with any computing device. A computing device as used herein refers to any device with a processor, a memory and a storage device that may execute instructions including, but not limited to, personal computers, server computers, computing tables, set top boxes, video game systems, personal video recorders, telephones, personal digital assistants (PDAs), portable computers, and laptop computers. These computing devices may run any operating system, including, for example, variations of the Linux, Unix, MS-DOS, Microsoft Windows, Palm OS, and Apple Mac OS X operating systems.

Although the techniques discussed herein are described with regard to a compact disk, the techniques may be implemented with any storage media in any storage devices included with or otherwise coupled or attached to a computing device. These storage media include, for example, magnetic media such as hard disks, floppy disks and tapes; optical media such as compact disks (CD-ROM and CD-RW) and digital versatile disks (DVD and DVD±RW); flash memory cards; and any other storage media. As used herein, a storage device is a device that allows for reading and/or writing to a storage medium. Storage devices include hard disk drives, DVD drives, flash memory devices and others.

By data unit, it is meant a frame, cell, datagram, packet or other unit of information.

While the present invention is described above in detail by way of a specific mode of carrying out the invention, it will be clear to those skilled in the art that the described embodiment can be modified and altered in various different ways without departing from the spirit and scope of the invention.

Thus, as described above, the present invention provides a setting management apparatus, a setting management method and a setting management computer program make it possible to define printing settings with an enhanced degree of freedom and contribute to improving the convenience for the use of printing processes.

It is claimed:

1. A setting management apparatus for managing setting information relating to image forming processes for forming images on respective sheets, the apparatus comprising:
a setting information acquiring section for acquiring the setting information defined corresponding to jobs of the image forming processes; and
a setting executing section for sequentially executing the image forming processes of a plurality of jobs at predetermined respective timings according to the setting information acquired by the setting information acquiring section for the plurality of jobs in response to the acquisition of the setting information for the plurality of jobs.

2. The apparatus according to claim 1, wherein
the setting executing section sequentially and continuously executes the image forming processes according to the setting information for the plurality of jobs and according to a command for starting the image forming processes issued by a user.

3. The apparatus according to claim 1, further comprising:
a display control section for causing the setting information acquired by the setting information acquiring section to be displayed after sorting it into the jobs; and
the display control section being adapted to display the acquired setting information in terms of the difference between it and predetermined standard setting information.

4. The apparatus according to claim 1, further comprising:
a display control section for causing the setting information acquired by the setting information acquiring section to be displayed after sorting it into the jobs; and
the display control section being adapted to display the setting information other than specific setting information in the acquired plurality of pieces of setting information in terms of the difference between it and the specific setting information in response to the acquisition of the setting information for a plurality of jobs.

5. A setting management apparatus for managing setting information relating to image forming processes for forming images on respective sheets, the apparatus comprising:
a setting information display section for displaying priority setting information indicating the priority given either to the image quality or the time required for an image forming process and parameter setting information on the parameters influencing the image quality and the processing time; and
a setting management section for modifying the parameter setting information or the priority setting information in response to any modification made to the priority setting information or the parameter setting information, whichever appropriate.

6. The apparatus according to claim 5, wherein
the setting information display section displays the defined contents of the priority setting information by means of a continuous value.

7. The apparatus according to claim 5, wherein
the setting information display section displays the priority setting information by means of a sliding bar adapted to be defined in terms of a continuous value according to the operation input of the user.

8. The apparatus according to claim 5, wherein
the setting management section modifies the parameter setting information or the priority setting information in response to any modification made to the priority setting information or the parameter setting information, whichever appropriate, according to a rule of correspondence defining the corresponding relationship of the priority setting information and the parameter setting information.

9. A setting management method for managing setting information relating to image forming processes for forming images on respective sheets, the method comprising:
a setting information acquiring step that acquires the setting information defined corresponding to jobs of the image forming processes; and
a setting executing step that sequentially executes the image forming processes of a plurality of jobs at predetermined respective timings according to the setting information acquired in the setting information acquiring step for the plurality of jobs in response to the acquisition of the setting information for the plurality of jobs.

10. The method according to claim 9, wherein
the setting executing step is adapted to sequentially and continuously execute the image forming processes according to the setting information for the plurality of jobs and according to a command for starting the image forming processes issued by a user.

11. A setting management method for managing setting information relating to image forming processes for forming images on respective sheets, the method comprising:
a setting information display step that displays priority setting information indicating the priority given either to the image quality or the time required for an image forming process and parameter setting information on the parameters influencing the image quality and the processing time; and
a setting management step that modifies the parameter setting information or the priority setting information in response to any modification made to the priority setting information or the parameter setting information, whichever appropriate.

12. The method according to claim 11, wherein
the setting information display step is adapted to display the defined contents of the priority setting information by means of a continuous value.

13. A setting management program causing a computer to execute an operation of managing setting information relating to image forming processes for forming images on respective sheets, the program comprising:
a setting information acquiring step that acquires the setting information defined corresponding to jobs of the image forming processes; and
a setting executing step that sequentially executes the image forming processes of a plurality of jobs at predetermined respective timings according to the setting information acquired in the setting information acquiring step for the plurality of jobs in response to the acquisition of the setting information for the plurality of jobs.

14. The program according to claim 13, wherein
the setting executing step is adapted to sequentially and continuously execute the image forming processes according to the setting information for the plurality of jobs and according to a command for starting the image forming processes issued by the user.

15. The program according to claim 13, further comprising:
a display control step that causes the setting information acquired in the setting information acquiring step to be displayed after sorting it into the jobs; and
the display control step being adapted to display the acquired setting information in terms of the difference between it and predetermined standard setting information.

16. The program according to claim 13, further comprising:
a display control step that causes the setting information acquired in the setting information acquiring step to be displayed after sorting it into the jobs; and
the display control step being adapted to display the setting information other than specific setting information in the acquired plurality of pieces of setting information in terms of the difference between it and the specific setting information in response to the acquisition of the setting information for a plurality of jobs.

17. A setting management program causing a computer to execute an operation of managing setting information relating to image forming processes for forming images on respective sheets, the program comprising:
a setting information display step that displays priority setting information indicating the priority given either to the image quality or the time required for an image forming process and parameter setting information on the parameters influencing the image quality and the processing time; and
a setting management step that modifies the parameter setting information or the priority setting information in response to any modification made to the priority setting information or the parameter setting information, whichever appropriate.

18. The program according to claim 17, wherein
the setting information display step is adapted to display the defined contents of the priority setting information by means of a continuous value.

19. The program according to claim 17, wherein
the setting information display step is adapted to display the priority setting information by means of a sliding bar adapted to be defined in terms of a continuous value according to the operation input of the user.

20. The program according to claim 17, wherein
the setting management step is adapted to modify the parameter setting information or the priority setting information in response to any modification made to the priority setting information or the parameter setting information, whichever appropriate, according to a rule of correspondence defining the corresponding relationship of the priority setting information and the parameter setting information.
